(19) United States
(12) Patent Application Publication
(10) Pub. No.: US 2005/0223052 A1
(43) Pub. Date: Oct. 6, 2005

(54) Method and integrated circuit for carrying out a multiplication modulo m

(76) Inventors: Manfred Schimmler, Bundesrepublik (DE); Viktor Bunimov, Bundesrepublik (DE)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/515,810

(22) PCT Filed: May 20, 2003
(86) PCT No.: PCT/DE03/01728

§ 371 Date: Nov. 24, 2004

(30) Foreign Application Priority Data
May 28, 2002 (DE) 102 23 853.7

(51) Int. Cl. G06F 7/00

(52) U.S. Cl. 708/492

(57) ABSTRACT

The invention relates to a method for carrying out a multiplication modulo M of two n-digit digital numbers (X, Y) in relation to a radix m by means of an integrated circuit. The inventive method consists of the following steps: conventionally determined partial products I=X<SB>1</SB>*Y(0=1=n−1), beginning with the highest-ranking place, are formed; the partial product (I) is added (4) to a subtotal multiplied by m, in order to form a new subtotal; the summands (S, C) of the new subtotal are added (5) to a value from a plurality of pre-calculated values (A) which are attributed to classes, in order to form a new subtotal; the new subtotal is used for the addition (4) of the next step (I−1); the new subtotal is approximately compared with the pre-determined classes in order to establish in which class the new subtotal falls; and the pre-calculated value (A) pertaining to the determined class is used as a summand for the corresponding addition (5) of the next step (i−1).

The invention relates to a method for carrying out a modulo M multiplication of two n-digit digital numbers X, Y using an integrated circuit, where M<mⁿ; X, Y<M.

The invention also relates to an integrated circuit for carrying out the method.

Modular multiplication of two integers X*Y mod M is part of virtually all cryptographic public key methods, that is to say, for example, of methods for checking access authorization to service programs.

Access authorization must be checked within a very short time, with the result that software solutions for carrying out the requisite calculations are out of the question owing to the amount of time they require or are not possible on account of the processor capacity being too small.

An integrated circuit which is used to carry out the requisite computation steps is therefore utilized as a hardware solution.

The traditional method for multiplying two binary numbers involves multiplying each bit xᵢ of the multiplicand X by the other multiplicand Y (xᵢ*Y). The products formed are added in the correct places to form the result X*Y. The product formed is multiplied by the reciprocal value of N in order to form the product X*Y mod M. The places before the decimal point of this result form the quotient Q. The result is the difference between X*Y and Q*M, namely the remainder which results when forming the quotient from X*Y using the modulus M.

The traditional calculation method results in binary numbers which have a large number of bits and in the use of a large amount of computation time.

Methods which are used to effect the requisite addition of the individual products immediately after they have been formed and, in addition, are used to reduce the bit length of the subtotals are therefore known.

In the case of the Montgomery method, the respectively formed individual product is added to a subtotal and a check is carried out to determine whether the least significant bit is “0”. If this is the case said bit is eliminated by means of a shift operation, which corresponds to division by two. However, if the last bit of the subtotal is “1”, the modulus M is added to it, as a result of which there is no change to the result of the calculation but the usually odd modulus (last bit=1) now produces a subtotal which has; a least significant bit “0” and is divided by 2.

A result T=X*Y*R⁻¹ mod M is thus determined. Modular multiplication by R² mod M (e.g.: R=2ⁿ), which is carried out in an identical computation operation, is therefore required.

Carrying out the multiplication therefore requires two multiplication iterations, that is to say twice the amount of time.

A modular reduction is also carried out in interleaved modular multiplication for interleaved addition of the individual results. A check is carried out after each step to determine whether the current partial cum is greater than 2¹ times the modulus M. M is subtracted if this is the case. This comparison operation is repeated. The remaining partial sum is then always loss than M. The division which is required in the elementary method and is computation intensive is concomitantly carried out, in this manner, by means of two respective real-time subtractions during the calculations. Since the intermediate results never become significantly greater than n bits, considerably area is saved in the integrated circuit. However, the respectively required comparison operation, which ultimately comprises a hidden addition (P−M) that likewise increases the complexity and extends the computation time, is problematic.

The invention is therefore based on the object of making it possible to carry out a modulo M multiplication (with the constraints mentioned initially) using a smaller amount of hardware area and/or computation time.

The following method steps are carried out according to the invention, in a method of the type mentioned initially, in order to achieve said object: conventional created partial products I=xᵢ*Y (0≦i≦n−1) are formed, beginning with the most significant digit
the partial product I is added to a subtotal, which has been multiplied by m, in order to form a new subtotal
the new subtotal in added to one value of a number of precalculated values A, which are associated with size classes, in order to form a new subtotal
the last n digits of the now subtotal are used for the addition in the next iteration (i−1)
the new subtotal is approximately compared with the predetermined size classes in order to determine the size claps into which the new subtotal falls the precalculated value A which belongs to the size classes determined is used as a summand for the corresponding addition in the next iteration (i−1).

The inventive method is thus essentially based on carrying out an interleaved multiplication. The problem with interleaved multiplication is the reduction of the sum formed, which can be used directly if the sum is between 0 and the modulus M but from which the modulus M must be subtracted once or twice if the subtotal formed is, on the one hand, >M and <2 M or, on the other hand, is >2 M. The comparison contains hidden additions thus increasing the calculation complexity again—in a similar way to the Montgomery method.

Instead of calculating the comparison, the invention carries out an approximate estimation which, for example, using the two most significant bits whose sum can assume the values 0 to S. This approximate estimation is carried out using precalculated correction values and is therefore possible with little computation complexity. In this case, the modulus M is not then subtracted, but the corresponding addition for the next iteration is carried out using the precalculated correction value for the size class determined.

The inventive method can thus be carried out in a single iteration and can therefore be carried out in half the computation time. The complexity of the circuit, that is to say the area required on the semiconductor chip, is of the same magnitude as in the Montgomery method.

The abovementioned object is also achieved by means of an integrated circuit which ir designed to carry out the inventive method and therefore contains a multiplier for forming the partial products I, at least one adder, and an assessment stage for forming a sum of the most significant digits of the summands and for selecting a precalculated correction value A, with the two most significant bits being used, in particular.

The invention can preferably be carried out using binary numbers but it is also possible, in an analogous manner, to use other digital number systems. The use of digital numbers having higher bases, in particular powers of 2, for example base 8, may be highly expedient, as is already known from the Montgomery method.

In the inventive method, the additions are preferably carried out using a carry-save adder. Carry-save addition avoids working with transfer bit; and, as a result, saves a considerable amount of computation time.

The invention will be explained in more detail below using an exemplary embodiment which is shown in the drawing, in which:

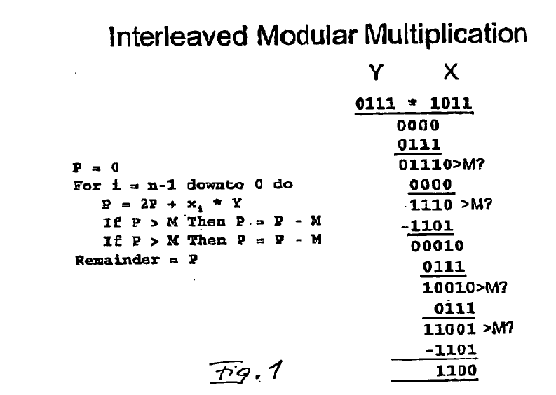

FIG. 1 shows a computation example of a conventional modular interleaved multiplication with the associated algorithm

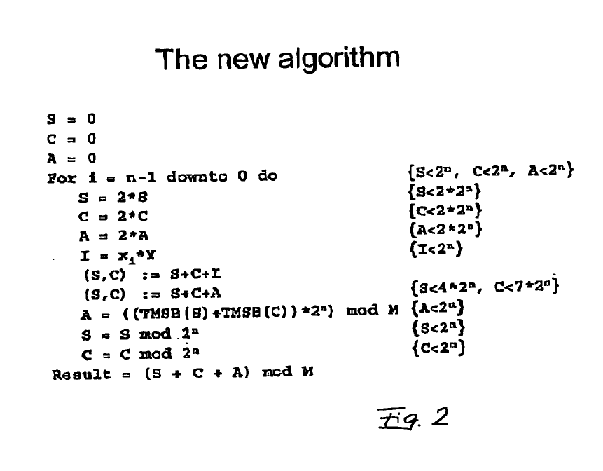

FIG. 2 shown a list for a first exemplary embodiment of the inventive algorithm for binary numbers

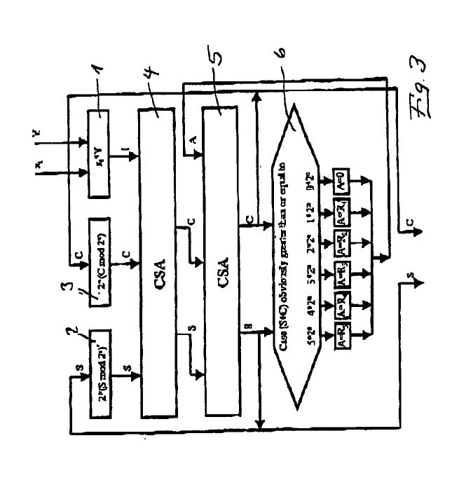

FIG. 3 shown a flowchart for executing the algorithm shown in FIG. 2

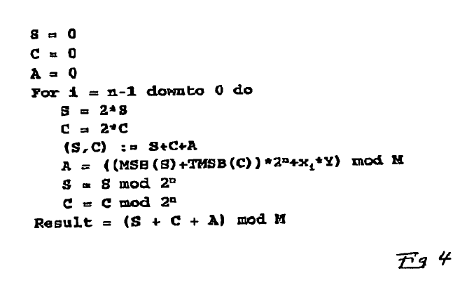

FIG. 4 shows a list for a second exemplary embodiment of the inventive algorithm for binary numbers

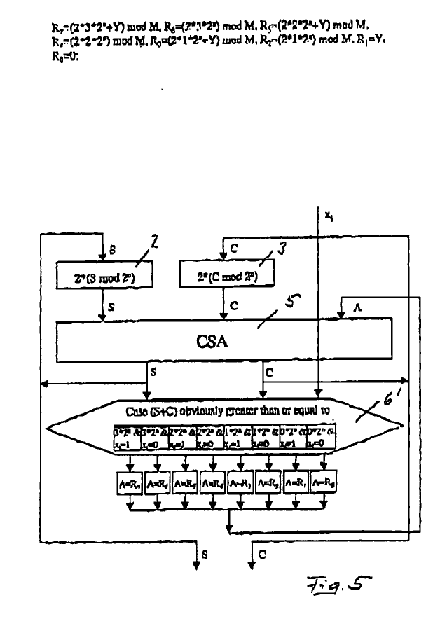

FIG. 5 shows a flowchart for executing the algorithm shown in FIG. 4.

Carrying out the modular multiplication P:=X*Y mod M would conventionally require the following computation steps
P:=X*Y
Q:=P div M
Remainder:=P−Q*M.

Very large intermediate results are produced in this type of calculation, thus entailing considerable disadvantages when using bit lengths of 1,024 or more, as are customary for encryption purposes. A division process must also be carried out. The complexity and computation time are extremely high.

In the interleaved modular multiplication shown in FIG. 1, an addition to form a subtotal is carried out for each computation step of the multiplication (which is carried out bit-by-bit), and this subtotal is reduced if it is greater than the modulus M.

The computation example shown in the drawing was designed for four bit values. The first row of the product calculation gives the output value 0000. The product xᵢ*Y, 0111 in the exemplary embodiment shown, is underneath said output value.

The sum now formed is compared with the modulus M (in this case: 1101=13). Since the sum P is not greater than the modulus M, the sum is now doubled (2*P) by appending a 0 as the least significant bit.

The multiplication xᵢ*Y is now carried out (0000) for the second bit and a sum is formed. Since the sum 1110 (=14) now formed in greater than M, M is then subtracted. The sum P formed in this manner is now doubled again by appending a 0 an the least significant bit. This is then followed by the calculation xᵢ*Y for the third bit etc. Once all four bits have been processed, the value P 1100 (=12) is produced as the remainder which gives the value X*Y mod M, with Y being 0111 (−7) and X being 1011 (−11) in the exemplary embodiment. The correct result 7*11 mod 13=12 is thus produced.

A first embodiment of the inventive algorithm shown in FIG. 2 is based on the principle of interleaved multiplication but uses a carry-save addition (CSA) with the summands S, C and A.

The summands are also doubled in the inventive algorithm, and a summation is carried out to form the intermediate products xᵢ*Y which are determined bit-by-bit. For the purpose of reduction, the two most significant bits of the summand S and of the summand C for the second carry-save addition are added in the exemplary embodiment shown and are formed into a value that is produced by appending n bits having the value 0. In other words, the n least significant bits of the summands S and C are ignored. In one preferred embodiment, the sum of the two most significant bits of S and C may be between 0 and 5. The associated values A for the six possible cases were calculated in advance, to be precise were immediately multiplied by a factor of 2 owing to the use of A−2*A, that is to say, apart from the value 0, the values
R₁=(2=2ⁿ)mod M
R₂=(4*2ⁿ)mod M
R₃=(6*2ⁿ)mod M
R₄=(8*2ⁿ)mod M
R₅=(10*2ⁿ)mod M

The class belonging to the sum of the two most significant bits of the summands S and C thus determines the value that in used for A.

The values of S and C from which the two most significant bits have been removed are then used as the summands S and C, thus ensuring that the bit length is reduced.

The flowchart shown in FIG. 3 illustrates the design of a corresponding layout for carrying out modular multiplication.

The intermediate products I=xᵢ*Y which are created bit-by-bit are formed in a multiplication stage 1.

Reduction stages 2 and 3 eliminate the bits whose significance is ≧2ⁿ and supply the summands S and C which have been formed in this manner, together with the intermediate product I, to a first carry-save adder 4.

A carry-save adder 4 was three inputs for each bit and carries out the addition. If all three input values are 0, the CSA 4 outputs the output value 00. The output value 01 is produced for 001 (order arbitrary), the output values 10 are produced for the input values 011, and the output values 11 are produced for the input values 111.

The trick of this arrangement is that no carry bits have to be transported and taken into account.

The output values C and S (formed in this manner) of the CSA 4 form two input values for a second CSA 5 which is supplied with a value A as a third input value. The value A is formed in an assessment stage 6 in which the output values S and C of the second CSA 5 are assessed. To this end, the two most significant bits of the value S and of the value C are added, and a check is then carried out to determine whether the sum of S+c is obviously greater than or equal to 0*2ⁿ, 1*2ⁿ . . . 5*2ⁿ. Based on the size class which has been determined in this manner, the value 0 or one of the precalculated values R₁ to R₅ is supplied, as the value A, to the second CSA 5 for the next computation cycle. At the end of the calculation, the values S+C form the result sought.

According to the second embodiment of the inventive algorithm shown in FIG. 4, trim two additions “+I” and “+A” are combined by selecting the correction value A in such a manner that it concomitantly includes the addition “+I”which signifies the addition of the partial product “xᵢ*Y”.

As FIG. 5 illustrates that, specifically for forming the partial product “xᵢ*Y”, binary numbers are only distinguished whether x₁=0 or xᵢ=1. The partial product xᵢ*Y can accordingly be only 0 or Y. For carrying out the computation task, the correction values A may therefore be the variables R₀-R₇. These eight possible correction values are calculated before the algorithm is used, are available as precalculated correction values A and are determined in accordance with the estimation in the assessment stage 6, (which corresponds to the estimation in the assessment stage 6 shown in FIG. 2), taking into account the case distinction xᵢ*Y=0 or xᵢ*Y=Y. In this case, the sum of the two most significant bits of the values S and c may only be between 0*2ⁿ and 3*2ⁿ, thus resulting in the eight possible correction values A. The multiplication stage 1 and the CSA 4 shown in FIG. 3 may thus be omitted as a result of the variant of the inventive algorithm shown in FIGS. 4 and 5.

It is evident that, when using a digital number system based on a higher base (for example 8), the number of precalculated correction values A is correspondingly increased since the product xᵢ*Y requires a greater case distinction in this case.

Since—apart from secondary calculations (which are of no consequence) with small numbers—the inventive method manages with one computation loop, the computation time is halved in comparison to the Montgomery method which has hitherto been regarded as the most favorable method,

1. A method for carrying out a module M multiplication of two n-digit digital numbers (X, Y)—relative to a base m—using an integrated circuit, where M<mⁿ; X, y<M, said method having the following method steps:
conventional created partial products I−Xᵢ*Y (0≦I≦n−1) are formed, beginning with the most significant digit
the partial product (I) is added (4) to a subtotal, which has been multiplied by m, in order to form a new subtotal
the new subtotal is added (5) to one of a number of precalculated values (A), which are associated with size classes, in order to form a new subtotal
the last n digits of the new subtotal are used for the addition (4) in the next iteration (I−1)
the new subtotal is approximately compared with the predetermined size classes in order to determine the size class into which the new subtotal falls
the precalculated value (A) which belongs to the size class determined is used as a summand for the corresponding addition (5) in the next iteration (I−1).

2. The method as claimed in claim 1, in which the precalculated values are multiples of mⁿ mod M, and the predetermined size classes are determined by lower limit values mⁿ which result in the multiples of mⁿ.

3. The method as claimed in claim 2, in which the approximate comparison with the sum of the two most significant places of the summands (S and C) is carried out using the values 0 to 5.

4. The method as claimed in claim 1, in which the partial product (I) is added, as a case distinction, during determination of the precalculated correction value (A) belonging to the size class determined, and the partial product (I) and the value (A) are added (4, 5) in a combined addition.

5. The method as claimed in claim 1, in which the computation is affected using binary numbers

6. An integrated circuit for carrying out a module M multiplication in accordance with the method as claimed in claim 1, said circuit containing a multiplier (1) for forming the partial products (I), at least one adder (4, 5), and an assessment stage (6) for forming a sum of the most significant places of the summands and for selecting a precalculated correction value (A).

7. The integrated circuit as claimed in claim 6, in which the sum of the two most significant places of the summands (S and C) is formed in the assessment stage.
